(19) United States
(12) Patent Application Publication
(10) Pub. No.: US 2011/0294934 A1
(43) Pub. Date: Dec. 1, 2011

(54) TWO-COMPONENT COATING COMPOSITIONS FOR FLEXIBLE COATINGS

(75) Inventors: Christian Wamprecht, Neuss (DE); Malte Homann, Odenthal (DE)

(73) Assignee: Bayer Material Science AG, Leverkusen (DE)

(21) Appl. No.: 13/147,235

(22) PCT Filed: Jan. 23, 2010
(86) PCT No.: PCT/EP2010/000408

§ 371 Date: Aug. 1, 2011

(30) Foreign Application Priority Data
Feb. 3, 2009 (DE) 10 2009 007 194.6

(51) Int. Cl. C08K 5/09; C09D 175/00

(52) U.S. Cl. 524/284; 524/590

(57) ABSTRACT

The invention relates to coating systems for producing fast-drying flexible coatings which are based on aromatic allophanate group-containing prepolymers and aliphatic polyisocyanates and aminofunctional polyaspartic esters as the curing agents.

The present invention relates to coating systems for producing quick-drying flexible coatings based on aromatic allophanate-group-containing prepolymers and aliphatic polyisocyanates and on amino-functional polyaspartic acid esters as hardeners.

Two-component coating systems based on polyurethane or polyurea are known and are already used in industry. They generally contain a liquid polyisocyanate component and a liquid isocyanate-reactive component. Highly crosslinked polyurea coatings are formed by the reaction of polyisocyanates with amines as the isocyanate-reactive component. However, primary amines and isocyanates usually react very quickly with one another. Typical pot or gel times are often only some seconds to a few minutes. For that reason such polyurea coatings cannot be applied manually, but only with special spraying equipment. Such coatings have excellent physical properties, however.

A method known from the literature for reducing this high reactivity is the use of prepolymers having a low NCO content. Flexible polyurea coatings can be produced using NCO-functional prepolymers in combination with amines.

U.S. Pat. No. 3,428,610 and U.S. Pat. No. 4,463,126 disclose the production of polyurethane/polyurea elastomers by curing NCO-functional prepolymers with aromatic diamines. These are preferably di-primary aromatic diamines having at least one alkyl substituent with 2 to 3 carbon atoms in ortho position to each amino group and optionally also methyl substituents, such as for example diethyltoluyldiamine (DETDA), in further ortho positions to the amino groups.

U.S. Pat. No. 3,428,610 and U.S. Pat. No. 4,463,126 describe a method for producing solvent-free elastic coatings in which NCO prepolymers based on isophorone diisocyanate (IPDI) and polyether polyols are cured at room temperature with sterically hindered di-primary aromatic diamines.

The disadvantage of such systems is that the aromatic diamines have a strong tendency to yellowness.

A further possibility for delaying the reaction between polyisocyanates and amines is to use secondary amines. EP-A 0 403 921, U.S. Pat. No. 5,126,170 and WO 2007/039133 disclose the formation of polyurea coatings by reacting polyaspartic acid esters with polyisocyanates. Polyaspartic acid esters have a low viscosity and a reduced reactivity to polyisocyanates and can therefore be used to produce solvent-free coating agents having an extended pot life. An additional advantage of polyaspartic acid esters is that the products are colourless.

However, colourless, aliphatic polyisocyanate prepolymers based on polyether polyols cure slowly with polyaspartic acid esters and the coatings often have a tacky surface. Polyisocyanate prepolymers according to WO 2007/039133 cure more quickly with polyaspartic acid esters, but acceptable mechanical end properties are often achieved only after several hours to days.

The object of the present invention was therefore to provide two-component coating agents for the production of polyurea coatings which have a sufficiently long pot life to allow manual two-component application and with which quick-drying, clear and as light-coloured as possible flexible coatings can be produced which have good application-related properties such as elasticity and hardness.

This object has now been achieved by the combination of specific allophanate polyisocyanates with polyaspartic acid esters.

The invention therefore provides two-component coating systems containing at least

A) a polyisocyanate component, consisting of
a. a polyisocyanate component based on an aromatic prepolymer containing allophanate groups
b. a polyisocyanate component based on a (cyclo)aliphatic polyisocyanate

B) amino-functional polyaspartic acid esters of the general formula (I)

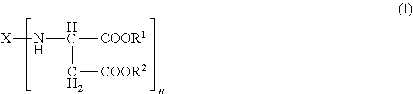

in which
X denotes an n-valent organic radical which is (formally) obtained by removing the primary amino groups from an n-valent polyamine,
R¹, R² denote identical or different organic radicals, which under the reaction conditions are inert with regard to isocyanate groups, and
n denotes a whole number of at least 2.
The allophanates used in component A) can be obtained for example by reacting

a1) one or more polyisocyanates based on diphenylmethane diisocyanate with

a2) one or more polyhydroxy compounds, at least one being a polyether polyol, to form an NCO-functional polyurethane prepolymer, and then subsequently allophanatising the urethane groups thereof formed in this way either partially or completely by addition of

a3) polyisocyanates, which can differ from those from a1), and

a4) catalysts

a5) optionally stabilisers.

Examples of suitable aromatic polyisocyanates a1) are 4,4′-diphenylmethane diisocyanate, 2,4′-diphenylmethane diisocyanate, and any mixtures of 4,4′- and 2,4′-diphenylmethane diisocyanate.

Mixtures of 4,4′- and 2,4′-diphenylmethane diisocyanate having a 2,4′-diphenylmethane diisocyanate content of over 55% are preferred in a1). Mixtures of 4,4′- and 2,4′-diphenylmethane diisocyanate having a 2,4′-diphenylmethane diisocyanate content of over 75% are particularly preferred, and most particularly preferably only 2,4′-diphenylmethane diisocyanate is used in a1).

Examples of suitable polyisocyanates in a3) are the same polyisocyanates as in a1) and moreover polyisocyanates based on 1,4-butane diisocyanate, 1,5-pentane diisocyanate, 1,6-hexane diisocyanate (hexamethylene diisocyanate, HDI), 4-isocyanatomethyl-1,8-octane diisocyanate (triisocyanatononane, TIN) or cyclic systems such as 4,4′-methylene bis(cyclohexyl isocyanate), 3,5,5-trimethyl-1-isocyanato-3-isocyanatomethylcyclohexane (isophorone diisocyanate, IPDI), and ω,ω′-diisocyanato-1,3-dimethylcyclohexane (H₆XDI) and 2,4- and/or 2,6-toluylene diisocyanate.

Polyisocyanates of the same type are preferably used in a1) and a3).

All polyhydroxy compounds known to the person skilled in the art which preferably have an average OH functionality of greater than or equal to 1.5 can be used as polyhydroxy compounds of component a2), wherein at least one of the compounds contained in a2) must be a polyether polyol.

Suitable polyhydroxy compounds which can be used in a2) are low-molecular-weight diols (e.g. 1,2-ethanediol, 1,3- or 1,2-propanediol, 1,4-butanediol), triols (e.g. glycerol, trimethylolpropane) and tetraols (e.g. pentaerythritol), polyether polyols, polyester polyols, polycarbonate polyols and polythioether polyols. Exclusively substances of the aforementioned type based on polyether are preferably used as polyhydroxy compounds in a2).

The polyether polyols used in a2) preferably have number-average molecular weights Mₙ of 300 to 20,000 g/mol, particularly preferably 1000 to 12,000 g/mol, most particularly preferably 2000 to 6000 g/mol.

Furthermore they preferably have an average OH functionality of ≧1.9, particularly preferably ≧1.95. The functionality is most preferably between ≧1.95 and ≦2.50.

Such polyether polyols can be obtained in a manner known per se by alkoxylation of suitable starter molecules with base catalysis or the use of double metal cyanide compounds (DMC compounds).

Particularly suitable polyether polyols of component A2) are those of the aforementioned type having a content of unsaturated end groups of less than or equal to 0.02 milliequivalents per gram of polyol (meq/g), preferably less than or equal to 0.015 meq/g, particularly preferably less than or equal to 0.01 meq/g (determination method ASTM D2849-69).

Such polyether polyols can be produced in a manner known per se by alkoxylation of suitable starter molecules, in particular using double metal cyanide catalysts (DMC catalysis). This is described for example in U.S. Pat. No. 5,158,922 (e.g. Example 30) and EP-A 0 654 302 (p. 5, line 26 to p. 6, line 32).

Suitable starter molecules for the production of polyether polyols are, for example, simple, low-molecular-weight polyols, water, organic polyamines having at least two N—H bonds or any mixtures of such starter molecules. Suitable alkylene oxides for the alkoxylation are in particular ethylene oxide and/or propylene oxide, which can be used in the alkoxylation in any sequence or in a mixture. Polyethers having a propylene oxide content of ≧75% are particularly preferred. Polyethers based on propylene oxide are most particularly preferred.

Preferred starter molecules for the production of polyether polyols by alkoxylation, in particular using the DMC method, are in particular simple polyols such as ethylene glycol, propylene glycol-1,2- and butanediol-1,4, hexanediol-1,6, neopentylglycol, 2-ethylhexanediol-1,3, glycerol, trimethylolpropane, pentaerythritol, and low-molecular-weight, hydroxyl-group-displaying esters of such polyols with dicarboxylic acids of the type cited below by way of example, or low-molecular-weight ethoxylation or propoxylation products of such simple polyols, or any mixtures of such modified or unmodified alcohols.

Production of the isocyanate-group-containing polyurethane prepolymers as an intermediate stage takes place by reacting the polyhydroxy compounds of component a2) with excess amounts of polyisocyanates from a1). The reaction generally takes place at temperatures of 20 to 140° C., preferably 40 to 100° C., optionally using catalysts known per se from polyurethane chemistry, such as for example tin compounds, e.g. dibutyl tin dilaurate, or tertiary amines, e.g. triethylamine or diazabicyclooctane.

Allophanatisation then subsequently takes place by reacting the isocyanate-group-containing polyurethane prepolymers with polyisocyanates a3), which can be the same as or different from those of component a1), with suitable catalysts a4) being added to the allophanatisation reaction. Acid additives of component a5) are then optionally added for stabilisation purposes and excess polyisocyanate is optionally removed from the product, for example by film distillation or extraction.

The molar ratio of the OH groups in the compounds of component a2) to the NCO groups in the polyisocyanates from a1) and a3) is preferably 1:1.5 to 1:20, particularly preferably 1 : 2 to 1:15, most particularly preferably 1:2 to 1:10.

Zinc(II) compounds are preferably used in a4) as catalysts, wherein these are particularly preferably zinc soaps of longer-chain, branched or unbranched, aliphatic carboxylic acids. Preferred zinc(II) soaps are those based on 2-ethylhexanoic acid and linear aliphatic C₄ to C₃₀ carboxylic acids. Most particularly preferred compounds of component a4) are Zn(II) bis(2-ethylhexanoate), Zn(II) bis(n-octoate), Zn(II) bis(stearate), Zn(II) acetylacetonate or mixtures thereof.

These allophanatisation catalysts are typically used in amounts of 5 ppm up to 5 wt. %, relative to the complete reaction mixture. 5 to 5000 ppm of the catalyst are preferably used, particularly preferably 20 to 2000 ppm.

Additives having a stabilising action can optionally also be added before, during or after allophanatisation. These can be acid additives such as Lewis acids (electron-deficient compounds) or Brønsted acids (protonic acids) or such compounds which release such acids when reacted with water.

These can be for example inorganic or organic acids or neutral compounds such as acid halides or esters, which react with water to form the corresponding acids. Hydrochloric acid, phosphoric acid, phosphoric acid ester, benzoyl chloride, isophthalic acid dichloride, p-toluenesulfonic acid, formic acid, acetic acid, dichloroacetic acid and 2-chloropropionic acid are cited here in particular.

The aforementioned acid additives can also be used to deactivate the allophanatisation catalyst. Moreover they improve the stability of the allophanates produced according to the invention, for example under thermal loading during film distillation or also after production when the products are in storage.

The acid additives are generally added in at least an amount such that the molar ratio of the acid centres of the acid additive and the catalyst is at least 1:1. An excess of the acid additive is preferably added, however.

If acid additives are used at all, they are preferably organic acids such as carboxylic acids or acid halides, such as benzoyl chloride or isophthalyl dichloride.

If excess diisocyanate is to be separated off, film distillation is the preferred method and it is generally performed at temperatures of 100 to 160° C. and under a pressure of 0.01 to 3 mbar. The residual monomer content thereafter is preferably less than 1 wt. %, particularly preferably less than 0.5 wt. % (diisocyanate).

All of the process steps can optionally be performed in the presence of inert solvents. Inert solvents are understood to be those which do not react with the starting materials under the stated reaction conditions. Examples are ethyl acetate, butyl acetate, methoxypropyl acetate, methyl ethyl ketone, methyl isobutyl ketone, toluene, xylene, aromatic or (cyclo)aliphatic hydrocarbon mixtures or any mixtures of such solvents. The reactions according to the invention are preferably performed without solvents, however.

The components involved can be added in any sequence, both during production of the isocyanate-group-containing prepolymers and during allophanatisation. Addition of the polyether polyol a2) to the polyisocyanate of components a1) and a3) followed by addition of the allophanatisation catalyst a4) is preferred, however.

Aliphatic and/or cycloaliphatic polyisocyanates based on di- or triisocyanates such as butane diisocyanate, pentane diisocyanate, hexane diisocyanate (hexamethylene diisocyanate, HDI), 4-isocyanatomethyl-1,8-octane diisocyanate (triisocyanatononane, TIN) or cyclic systems such as 4,4′-methylene bis(cyclohexyl isocyanate), 3,5,5-trimethyl-1-isocyanato-3-isocyanatomethyl-cyclohexane (isophorone diisocyanate, IPDI), and ω,ω′-diisocyanato-1,3-dimethylcyclohexane (H₆XDI) are used as the polyisocyanate component b).

Polyisocyanates based on hexane diisocyanate (hexamethylene diisocyanate, HDI), 4,4′-methylene bis(cyclohexyl isocyanate) and/or 3,5,5-trimethyl-1-isocyanato-3-isocyanatomethyl cyclohexane (isophorone diisocyanate, IPDI) are preferably used in the polyisocyanate component b). Most particularly preferred polyisocyanates of component b) are those based on HDI.

Suitable polyisocyanates for b) are commercial polyisocyanates, i.e. above all the known modification products of the aforementioned simple diisocyanates containing urethane groups, uretdione groups, allophanate groups, biuret groups, isocyanurate groups and iminooxa-diazinedione groups.

The polyisocyanates containing urethane groups include for example the reaction products of 1-methyl-2,4- and optionally 1-methyl-2,6-diisocyanatocyclohexane with deficit amounts of trimethylolpropane or mixtures thereof with simple diols, such as for example the isomeric propanediols or butanediols. The production of such polyisocyanates containing urethane groups in virtually monomer-free form is described for example in DE-A 1 090 196.

The polyisocyanates containing biuret groups include in particular those based on 1,6-diisocyanatohexane, the production of which is described for example in EP-A 0 003 505, DE-A 1 101 394, U.S. Pat. No. 3,358,010 or U.S. Pat. No. 3,903,127.

The polyisocyanates containing isocyanurate groups include in particular the trimers or mixed trimers of the diisocyanates cited above by way of example, such as for example the aliphatic or aliphatic-cycloaliphatic trimers or mixed trimers based on 1,6-diisocyanatohexane and/or isophorone diisocyanate, which can be obtained for example in accordance with U.S. Pat. No. 4,324,879, U.S. Pat. No. 4,288,586, DE-A 3 100 262, DE-A 3 100 263, DE-A 3 033 860 or DE-A 3 144 672.

The polyisocyanates containing iminooxadiazinedione groups include in particular the trimers or mixed trimers of the diisocyanates cited above by way of example, such as for example the aliphatic trimers based on 1,6-diisocyanatohexane, which are obtainable for example in accordance with EP-A 0 962 455, EP-A 0 962 454 or EP-A 0 896 009.

The polyisocyanates used according to the invention generally have an isocyanate content of 5 to 25 wt. %, an average NCO functionality of 2.0 to 5.0, preferably 2.8 to 4.0, and a residual content of monomeric diisocyanates used in their production of less than 2 wt. %, preferably less than 0.5 wt. %. Any mixtures of the polyisocyanates cited by way of example can of course also be used.

In a preferred embodiment of the invention the polyisocyanates of components a1) and a3) are placed in a suitable reaction vessel and heated to 40 to 100° C., optionally whilst stirring. Once the desired temperature has been reached, the polyhydroxy compounds of component a2) are then added whilst stirring, and the mixture is stirred until the theoretical NCO content of the polyurethane prepolymer to be expected according to the chosen stoichiometry is reached or almost reached. Now the allophanatisation catalyst a4) is added and the reaction mixture is heated to 50 and 100° C. until the desired NCO content is reached or almost reached. Following the addition of acid additives as stabilisers the reaction mixture is cooled or sent directly for film distillation. Here the excess polyisocyanate is separated off at temperatures of 100 to 160° C. and under a pressure of 0.01 to 3 mbar down to a residual monomer content of less than 1%, preferably less than 0.5%. Further stabiliser can optionally be added after film distillation. Then the polyisocyanate a) that is obtained is mixed with the polyisocyanate component b).

In a further particular embodiment of the invention the polyisocyanates of components a1) and a3) are placed in a suitable reaction vessel and heated to 40 to 100° C., optionally whilst stirring. Once the desired temperature has been reached, the polyhydroxy compounds of component a2) are then added whilst stirring, and the mixture is stirred until the theoretical NCO content of the polyurethane prepolymer to be expected according to the chosen stoichiometry is reached or almost reached. Now the allophanatisation catalyst a4) and the polyisocyanate component b) are added and the reaction mixture is heated to 50 and 100° C. until the desired NCO content is reached or almost reached. Following the addition of acid additives as stabilisers the reaction mixture is cooled or sent directly for film distillation as described above.

Such allophanates a) used in the claimed two-component coating systems typically correspond to the general formula (II),

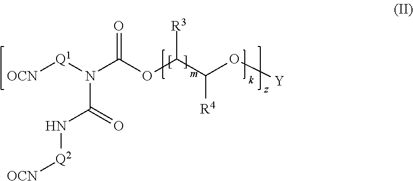

in which

Q¹ and Q² are independently of each other the radical of an aromatic diphenylmethane diisocyanate isomer of the stated type,

R³ and R⁴ are independently of each other hydrogen or a C₁-C₄ alkyl radical, wherein R³ and R⁴ are preferably hydrogen and/or methyl groups and the meaning of R³ and R⁴ can differ in each repeating unit k,

Y is the radical of a starter molecule of the stated type having a functionality of 2 to 6, and hence

z is a number from 2 to 6, which through the use of different starter molecules naturally does not have to be a whole number, and

k preferably corresponds to the number of monomer units such that the number-average molecular weight of the polyether underlying the structure is 300 to 20,000 g/mol, and

m is 1 or 3.

Allophanates a) are preferably obtained which correspond to the general formula (III),

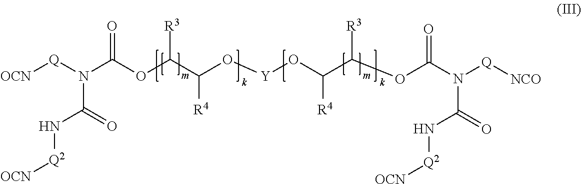

in which

Qdenotes the radical of an aromatic diphenylmethane diisocyanate isomer of the stated type,

R³ and R⁴ independently of each other denote hydrogen or a C₁-C₄ alkyl radical, wherein R³ and R⁴ are preferably hydrogen and/or methyl groups and wherein the meaning of R³ and R⁴ can differ in each repeating unit m,

Y denotes the radical of a difunctional starter molecule of the stated type and

k corresponds to the number of monomer units such that the number-average molecular weight of the polyether underlying the structure is 300 to 20,000 g/mol, and

m is equal to 1 or 3.

As polyols based on polymerised ethylene oxide, propylene oxide or tetrahydrofuran are generally used to produce the allophanates of formula (II) and (III), then at least one radical out of R³ and R⁴ is particularly preferably hydrogen if m=1 in formulae (II) and (III) and if m=3 then R³ and R⁴ are hydrogen.

The allophanates a) used according to the invention in A) typically have number-average molecular weights of 1181 to 50,000 g/mol, preferably 1300 to 10,000 g/mol and particularly preferably 2000 to 6000 g/mol.

The polyisocyanate mixtures comprising allophanates a) and the (cyclo)aliphatic polyisocyanates b) used according to the invention in A) typically have viscosities at 23° C. of 500 to 100,000 mPas, preferably 500 to 50,000 mPas and particularly preferably 750 to 20,000 mPas, most particularly preferably 1000 to 10,000 mPas.

Amino-functional aspartic acid esters B) are used as combination and reaction partners for the polyisocyanate mixtures A).

Group X in formula (I) of the polyaspartic acid esters of component B) is preferably based on an n-valent polyamine selected from the group consisting of ethylene diamine, 1,2-diaminopropane, 1,4-diaminobutane, 1,6-diaminohexane, 2,5-diamino-2,5-dimethylhexane, 2,2,4- and/or 2,4,4-trimethyl-1,6-diaminohexane, 1,11 -diaminoundecane, 1,12-diaminododecane, 1-amino-3,3,5-trimethyl-5-aminomethyl cyclohexane, 2,4- and/or 2,6-hexahydrotoluylene diamine, 2,4′- and/or 4,4′-diaminodicyclohexylmethane, 3,3′-dimethyl-4,4′-diaminodicyclohexylmethane, 2,4,4′-triamino-5-methyldicyclohexylmethane, and polyether polyamines having aliphatically bonded primary amino groups with a number-average molecular weight Mₙ of 148 to 6000 g/mol.

Group X is particularly preferably based on 1,4-diaminobutane, 1,6-diaminohexane, 2,2,4- and/or 2,4,4-trimethyl-1,6-diaminohexane, 1-amino-3,3,5-trimethyl-5-aminomethyl cyclohexane, 4,4′-diaminodicyclohexylmethane or 3,3′-dimethyl-4,4′-diaminodicyclohexylmethane.

With regard to the radicals R¹ and R² the phrase “under the reaction conditions are inert with regard to isocyanate groups” means that these radicals contain no groups having Zerewitinoff-active hydrogen (CH acid compounds; cf. Römpp Chemie Lexikon, Georg Thieme Verlag Stuttgart), such as OH, NH or SH.

R¹ and R² are preferably independently of each other C₁ to C₁₀ alkyl radicals, particularly preferably methyl or ethyl radicals.

If X is based on 2,4,4′-triamino-5-methyldicyclohexylmethane, then R¹ preferably equals R² equals ethyl.

In formula (I) n is preferably a whole number from 2 to 6, particularly preferably 2 to 4.

The production of the amino-functional polyaspartic acid esters B) takes place in a manner known per se by reacting the corresponding primary polyamines of the formula

X—[NH₂]ₙ

with maleic or fumaric acid esters of the general formula

R¹OOC—CH═CH—COOR²

Suitable polyamines are the diamines cited above as a basis for group X.

Examples of suitable maleic or fumaric acid esters are maleic acid dimethyl ester, maleic acid diethyl ester, maleic acid dibutyl ester and the corresponding fumaric acid esters.

Production of the amino-functional polyaspartic acid esters B) from the specified starting materials preferably takes place within the temperature range from 0 to 100° C., wherein the starting materials are used in proportions such that at least one, preferably exactly one, olefinic double bond is allotted to each primary amino group, wherein following the reaction, starting materials used in excess can optionally be separated off by distillation. The reaction can be performed in bulk or in the presence of suitable solvents such as methanol, ethanol, propanol or dioxane or mixtures of such solvents.

Both individual amino-functional aspartic acid esters B) and mixtures of several amino-functional aspartic acid esters can be used in the two-component coating systems according to the invention. Moreover, further amino-functional compounds, such as for example polyether polyamines having 2 to 4, preferably 2 to 3 and particularly preferably 2 aliphatically bonded primary amino groups and a number-average molecular weight Mₙ of 148 to 12,200, preferably 148 to 8200, particularly preferably 148 to 4000 and most particularly preferably 148 to 2000 g/mol. Further suitable amino-functional compounds as crosslinkers B) are low-molecular-weight aliphatic and/or cycloaliphatic diamines and triamines, such as for example ethylene diamine, 1,2-diaminopropane, 1,4-diaminobutane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1-amino-3,3,5-trimethyl-5-aminomethyl cyclohexane, 2,4- and/or 2,6-hexahydrotoluylene diamine, 2,4′- and/or 4,4′-diaminodicyclohexylmethane, 3,3′-dimethyl-4,4′-diaminodicyclohexylmethane, 2,4,4′-triamino-5-methyldicyclohexylmethane, Polyclear 136® (modified IPDA, BASF AG, Ludwigshafen), aromatic diamines and triamines having at least one alkyl substituent with 1 to 3 carbon atoms at the aromatic ring, such as for example 2,4-toluylene diamine, 2,6-toluylene diamine, 1-methyl-3,5-diethyl-2,4-diaminobenzene, 1,3-diethyl,2,4-diaminobenzene, 1-methyl-3,5-diethyl-2,6-diaminobenzene, 1,3,5-triethyl-2,6-diaminobenzene, 3,5,3′,5′-tetraethyl-4,4′-diaminodiphenylmethane, 3,3′-dimethyl-4,4′-diaminodiphenylmethane, 1-ethyl-2,4-diaminobenzene, 1-ethyl-2,6-diaminobenzene, 2,6-diethylnaphthylene-1,5-diamine, and optionally blocked polyamines, such as for example ketimines or aldimines up to an amount of 50 wt. %, relative to the proportion of aspartic acid esters in component B) can be incorporated, by means of which the hardness of the coating can be increased. The ratio of free and/or blocked amino groups to free NCO groups in the two-component coating systems according to the invention is preferably 0.5:1 to 1.5:1, particularly preferably 1:1 to 1.5:1.

The individual components are mixed together to produce the two-component coating systems according to the invention.

The cited coating agents can be applied to surfaces by the methods known per se, such as spraying, dipping, flow coating, rolling, brushing or pouring. After any solvents optionally present have been allowed to evaporate, the coatings then cure under ambient conditions or also at elevated temperatures of for example 40 to 200° C.

The cited coating agents can be applied for example to metals, plastics, ceramics, glass and to natural substances, wherein the cited substrates can first have undergone an optionally necessary pretreatment.

### EXAMPLES

The NCO contents were determined by back titration with hydrochloric acid of di-n-butylamine added in excess. The viscosities were determined at 23° C. using a rotary viscometer (MCR 51) from Anton Paar.

Aliphatic polyisocyanates used:

Desmodur N 3400®: Aliphatic polyisocyanate from Bayer MaterialScience AG based on hexamethylene diisocyanate with an NCO content of 21.8 wt. %.

Desmodur N 3600®: Aliphatic polyisocyanate from Bayer MaterialScience AG based on hexamethylene diisocyanate with an NCO content of 23.0 wt. %.

Desmodur XP 2580®: Aliphatic polyisocyanate from Bayer MaterialScience AG based on hexamethylene diisocyanate with an NCO content of 20.0 wt. %.

Desmodur XP 2410®: Aliphatic polyisocyanate from Bayer MaterialScience AG based on hexamethylene diisocyanate with an NCO content of 21.5 wt. %.

Unless otherwise specified, all percentages relate to weight.

### Production of Polyisocyanate A1

0.35 g of dibutyl tin(II) dilaurate (DBTL) were added to 728.7 g of 2,4′-diphenylmethane diisocyanate in a 5-litre reaction vessel under a nitrogen atmosphere, then the mixture was heated to 80° C. whilst stirring. Then 1458.5 g of a polypropylene glycol which had been produced by means of DMC catalysis (base-free) were added within 2 hours (content of unsaturated groups <0.01 meq/g, molecular weight 2000 g/mol, OH value 56, theoretical functionality 2). The reaction mixture was then heated at 80° C. until an NCO content of approx. 8.4% was achieved. Then the temperature was increased to 100° C. and after adding 1.05 zinc(II) acetylacetonate the reaction mixture was stirred until the NCO content was approximately 5.6% or constant. It was then cooled to 50° C. and 1312.5 g of Desmodur N 3400 were added through a dropping funnel. The mixture was stirred for a further 30 minutes at 50° C., then cooled to 30° C. and the product obtained was filtered off into an appropriate container under a nitrogen flow.

A clear product with an NCO content of 12.9% and a viscosity of 2370 mPas (23° C.) was obtained.

### Production of Polyisocyanate A2

The same procedure was followed as for polyisocyanate A1), but Desmodur XP 2580 was used in place of Desmodur N 3400.

A clear product with an NCO content of 11.9% and a viscosity of 3770 mPas (23° C.) was obtained.

### Production of Polyisocyanate A3

The same procedure was followed as for polyisocyanate A3), but Desmodur® XP 2410 was used in place of Desmodur® N 3400.

A clear product with an NCO content of 12.9% and a viscosity of 4620 mPas (23° C.) was obtained.

### Production of Polyisocyanate A4

The same procedure was followed as for polyisocyanate A1), but Desmodur® N 3600 was used in place of Desmodur® N 3400.

A clear product with an NCO content of 12.7% and a viscosity of 13,600 mPas (23° C.) was obtained.

### Production of Polyisocyanate A5

The same procedure was followed as for polyisocyanate A3) but Desmodur® XP 2410 was added at the same time as the zinc(II) acetylacetonate and the allophanatisation reaction was performed in the presence of Desmodur® XP 2410.

A clear product with an NCO content of 10.8% and a viscosity of 9590 mPas (23° C.) was obtained.

### Production of Polyaspartic Acid Ester B1

344 g (2 mol) of maleic acid diethyl ester were added dropwise at 50° C. to 210 g (2 eq.) of 4,4′-diaminodicyclohexylmethane whilst stirring. On completion of the addition the mixture was stirred for a further 90 h at 60° C. under an N₂ atmosphere and dehydrated at 1 mbar for the last two hours. A liquid product with an equivalent weight of 277 g was obtained.

### Production of Polyaspartic Acid Ester B2

344 g (2 mol) of maleic acid diethyl ester were added dropwise at 50° C. to 238 g (2 eq.) of 3,3′-dimethyl-4,4′-diaminodicyclohexylmethane whilst stirring. On completion of the addition the mixture was stirred for a further 90 h at 60° C. under an N₂ atmosphere and dehydrated at 1 mbar for the last two hours. A liquid product with an equivalent weight of 291 g was obtained.

### Production of Polyaspartic Acid Ester B3

344 g (2 mol) of maleic acid diethyl ester were added dropwise at 50° C. to 116 g (2 eq.) of 2-methylpentane methylenediamine-1,5 whilst stirring. On completion of the addition the mixture was stirred for a further 90 h at 60° C. under an N₂ atmosphere and dehydrated at 1 mbar for the last two hours. A liquid product with an equivalent weight of 234 g was obtained.

### Production of An Aliphatic Prepolymer Containing Allophanate Groups (Comparison)

90 mg of isophthalic acid dichloride were first added to 2520.7 g of 1,6-hexane diisocyanate and then the mixture was heated to 100° C. whilst stirring. Then 1978.5 g of a polypropylene glycol which had been produced by means of DMC catalysis (base-free) were added within 3 hours (content of unsaturated groups <0.01 meq/g, molecular weight 2000 g/mol, OH value 56, theoretical functionality 2). The reaction mixture was then heated at 100° C. until an NCO content of 26.1% was achieved. Then the temperature was reduced to 90° C. and after adding 360 mg of zinc(II) bis(2-ethylhexanoate) the reaction mixture was stirred until the NCO content was 24.3%. After adding 360 mg of isophthalic acid dichloride the excess 1,6-hexane diisocyanate was removed at 0.5 mbar and 140° C. by film distillation.

A clear, colourless product with an NCO content of 5.9%, a viscosity of 2070 mPas (23° C.) and a residual content of free HDI of <0.03% was obtained.

### Production of Coatings

The polyisocyanates A1) and A2) were mixed with the amino-functional polyaspartic acid esters B2), B3) or mixtures of B2) and B3) at room temperature, maintaining an NCO/NH ratio of 1.1 : 1. Corresponding films were then applied to a glass plate using a 150 μm knife. The composition and properties of the coatings are summarised in Table 1.

TABLE 1
Examples 1 to 5 - composition and properties of the films

| Examples | 1 | 2 | 3 | 4 | Comparison |
|---|---|---|---|---|---|
| Polyaspartic acid ester | 100.0 | — | 50.0 | 50.0 | 100.0 |
| B2 [g] | | | | | |
| Polyaspartic acid ester | — | 100.0 | 50.0 | 50.0 | |
| B3 [g] | | | | | |
| Polyisocyanate A1) [g] | 153.0 | | 140.5 | — | |
| Polyisocyanate A2) [g] | — | 165.9 | — | 152.3 | |
| Allophanate- | | | | | 280.7 |
| containing | | | | | |
| prepolymer [g] | | | | | |
| NH:NCO | 1:1.1 | 1:1.1 | 1:1.1 | 1:1.1 | 1:1.1 |
| Pot life | 2 min | 2 min | 3.5 min | 4 min | 24 min |
| Pendulum hardness: | | | | | |
| (150 μm wet film) | | | | | |
| after 7 d | 42″ | 40″ | 59″ | 53″ | 32″ |
| Shore hardness D: | | | | | |
| DIN 53505 | | | | | |
| after 7 d | 33 | 37 | 55 | 52 | 27 |
| Tensile strength ISO | | | | | |
| EN 527: | | | | | |
| Breaking stress: (MPa) | 7.8 | 8.1 | 10.0 | 8.7 | 2.4 |
| Standard deviation | 0.3 | 0.1 | 0.1 | 0.2 | 0.3 |
| Nominal elongation at | 248 | 205 | 65 | 129 | 52 |
| break: (%) | | | | | |
| Standard deviation | 6.5 | 5.2 | 3.7 | 4.8 | 4.5 |

The polyisocyanate mixtures A1) and A2) are based in principle on the same structural units, with the difference that the aliphatic polyisocyanate component b) is varied. Owing to their good compatibility, high functionality and good flexibilising properties, non-tacky, flexible, tough and clear films were obtained within 2 h which had very good mechanical properties, such as high tensile strength and high elongation at break. With the purely aliphatic allophanates, on the other hand, although curing was relatively rapid, it was only after 24 h that films were obtained having usable mechanical properties, albeit well below those of the binder combinations according to the invention in terms of mechanical values.

1.-12. (canceled)

13. A two-component coating system comprising
A) a polyisocyanate component, consisting of
a. a polyisocyanate component based on an aromatic prepolymer having allophanate groups
b. a polyisocyanate component based on a (cyclo)aliphatic polyisocyanate
B) amino-functional polyaspartic acid esters of the general formula (I) 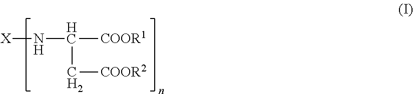
wherein
X represents an n-valent organic radical which is obtained by removing the primary amino groups from an n-valent polyamine,
R¹, R² represents, independently of one another, organic radicals, which under the reaction conditions are inert to isocyanate groups, and
n represents a whole number of at least 2.

14. The two-component coating system according to claim 13, wherein the aromatic allophanates used in A) are produced by reacting
A1) one or more diphenylmethane diisocyanate isomers
A2) one or more polyhydroxy compounds, at least one being a polyether polyol, to form an NCO-functional polyurethane prepolymer, and then subsequently allophanatising the prepolymer's urethane groups partially or completely by addition of
A3) polyisocyanates, which can be the same or different from the one or more diphenylmethane diisocyanate isomers Al), and
A4) catalysts and
A5) optionally stabilisers.

15. The two-component coating system according to claim 14, wherein components A1) and A3) comprise mixtures of 4,4′-diphenylmethane diisocyanate and 2,4′-diphenylmethane diisocyanate.

16. The two-component coating system according to claim 14, wherein components A1) and A3) comprise 2,4′-diphenylmethane diisocyanate.

17. The two-component coating system according to claim 14, wherein the catalysts A4) comprise zinc(II) compounds.

18. The two-component coating system according to claim 17, wherein the zinc(II) compounds are selected from the group consisting of zinc(II) bis(2-ethylhexanoate), zinc acetylacetonate, Zn(II) bis(n-octoate), Zn(II) bis(stearate) and mixtures thereof.

19. The two-component coating system according to claim 14, wherein the one or more polyhydroxy compounds A2) consists of polyether polyols having number-average molecular weights Mₙ of 2000 to 6000 g/mol, an average OH functionality of greater than or equal to 1.95 and a degree of unsaturated end groups of less than or equal to 0.01 meq/g in accordance with ASTM D2849-69.

20. The two-component coating system according to claim 13, wherein the polyisocyanate component b) comprise polyisocyanates based on hexamethylene diisocyanate.

21. The two-component coating system according to claim 14, wherein the molar ratio of OH groups in the compounds of component A2) to the NCO groups in the polyisocyanates from A1) and A3) is 1:2 to 1:10.

22. The two-component coating system according to claim 14, wherein the stabilisers A5) comprise inorganic or organic acids, acid halides or esters.

23. The two-component coating system according to claim 13, wherein up to 50 wt. % of the amino-functional polyaspartic acid esters of the general formula (I) are replaced by amino-functional polyethers, short-chain diamines and/or optionally blocked polyamines.

24. A coating obtained from the two-component coating system according to claim 13.

25. A substrate coated with the coating according to claim 24.
